(19) United States
(12) Patent Application Publication
(10) Pub. No.: US 2014/0034165 A1
(43) Pub. Date: Feb. 6, 2014

(54) THREE-POSITION VALVE FOR WATER SUPPLY SYSTEMS

(71) Applicants: Rafael Alcaraz Sencianes, Girona (ES); Jaime Lorenzo Felip, Girona (ES)

(72) Inventors: Rafael Alcaraz Sencianes, Girona (ES); Jaime Lorenzo Felip, Girona (ES)

(21) Appl. No.: 14/110,040

(22) PCT Filed: Apr. 4, 2012
(86) PCT No.: PCT/ES12/00089

§ 371 Date: Oct. 4, 2013

(30) Foreign Application Priority Data
Apr. 5, 2011 (ES) P201100395

(51) Int. Cl. E03C 1/04; F16K 5/06

(52) U.S. Cl. CPC E03C 1/04; F16K 5/06
USPC 137/614.2; 251/315.01

(57) ABSTRACT

The present invention relates to three-position faucet for water supply systems, formed by a body (1) housing a ball (3) that can rotate in order to establish positions for opening and closing the passage through the faucet, the ball (3) having a side conduit (14) communicating with another perpendicular downward-oriented conduit (15), whereas another conduit (16) or a smaller diameter extends from a perpendicular side area to the conduit (14), such that the conduit (15) is facing as outlet conduit (6), whereas depending on the rotation of the ball (3), the conduit (14), the conduit (16) or the blind portion opposite any of them can be arranged facing an inlet conduit defined by a tubular bushing (5), for establishing different passage positions or for closing the faucet.

### FIELD OF THE ART

The present invention relates to the control of passage in water supply pipes, particularly in relations to the supply from water supply systems to consumers, proposing a ball type faucet allowing three functional positions corresponding to: an open passage arrangement, a closed passage arrangement and a reduced passage arrangement, for different circumstances that may arise in consumer water supply.

### STATE OF THE ART

There are different types of faucets on the market for closing and opening fluid pipes, such as those having a ball with a hole going through it, the communication or interruption of the passage between two pipes coupled to the faucet on both sides is determined by means of the rotation of said ball.

Conventional faucets of this type are efficient for closing and opening the passage in the pipes of application, but in specific services, such as water supply from a consumer water supply system, circumstances that may vary depending on the users arise, such that in addition to opening and closing, other arrangements may have to be established for partial supply according to the users' particularities.

To that end, supply pipe passage flow regulation through is required, however conventional faucets for closing and opening supply are not envisaged for said regulation, whereby flow regulation for intermediate passage conditions is roughly done by means of a partial rotation of the faucet between the closing and opening positions, according to the criterion of the operator performing the maneuver, such regulation being rather imprecise.

### OBJECT OF THE INVENTION

The invention proposes a faucet for water supply pipes, of the type comprising a ball that can be rotated in order to determine different functional positions, according to an embodiment this proposed faucet being envisaged to allow establishing in precise positions an open passage arrangement, a closed passage arrangement and a reduced passage arrangement for a specific partial flow.

To that end, said faucet object of the invention comprises a rotary ball that can be rotated between three positions with 90° rotations between the different positions, said ball having a conduit which is open from a side area to the middle area, from where there is arranged in continuation another conduit opening perpendicularly downwards, whereas another conduit of a smaller diameter communicates with the first conduit from a perpendicular side position, the ball being provided in the upper portion with a slot in which a rod that can be rotated by means of a drive lever is coupled.

A functionally advantageous faucet with which three positions that allow covering various possibilities that may be required in consumer water supply service is thus obtained.

Particularly, the faucet allows establishing, under those conditions, an open passage arrangement in which the flow reaching the faucet completely passes through it; a closer passage arrangement in which the circulation passing through the faucet is completely interrupted; and a reduced passage arrangement with which a partial supply can be provided, for example in water restriction periods, or a water supply with minimum flow can be provided in special situations.

Based on the foregoing, said faucet object of the invention has particularly advantageous features for application in consumer water supply systems, acquiring its own identity and preferred character for said function.

### DESCRIPTION OF THE DRAWINGS

FIG. 1 shows an exploded and sectioned view of the assembly of a faucet for water passage formed according to the invention.

FIG. 2 is a side view of the faucet of the preceding figure assembled.

FIG. 3 is a corresponding profile view with respect to the preceding figure.

FIG. 4 is a sectioned view of the ball of a faucet according to the invention, with a bushing determining the reduced passage in the exploded position with respect to the assembly in said ball.

FIG. 5 is a sectioned side view of the faucet of FIGS. 1 to 3 in the open passage position.

FIG. 6 is a top plan view of the faucet in the position of the preceding figure.

FIG. 7 is a sectioned side view of said faucet of FIGS. 1 to 3 in the closed passage position.

FIG. 8 is a top plan view of the faucet in the position of the preceding figure.

FIG. 9 is a sectioned side view of that faucet of FIGS. 1 to 3 in the reduced passage position.

FIG. 10 is a top plan view of the faucet in the position of the preceding figure.

FIG. 11 is a sectioned side view of an embodiment of the faucet object of the invention with a lower outlet bent in the horizontal direction.

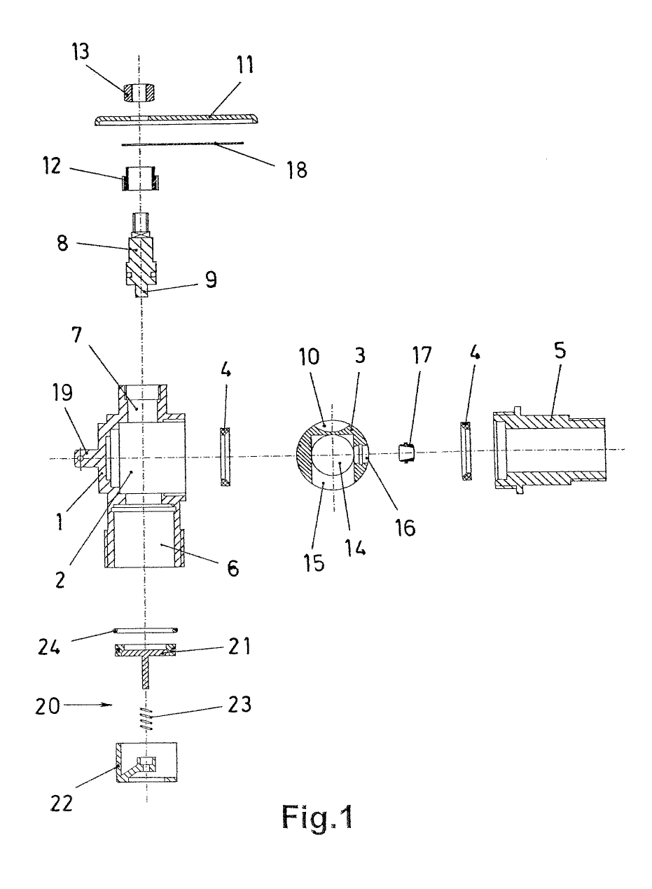

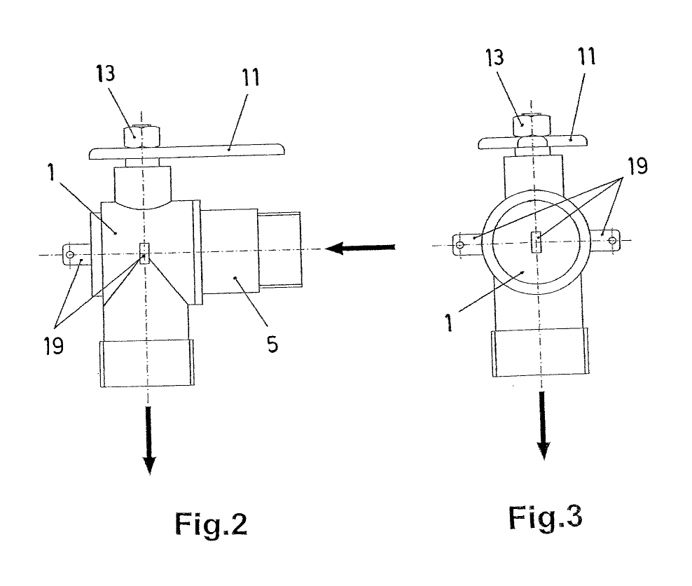

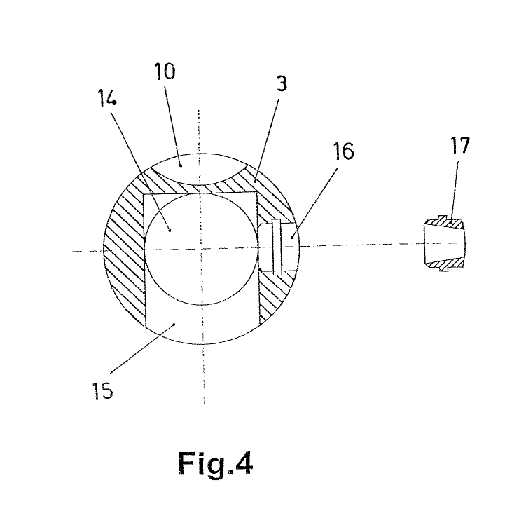

### DETAILED DESCRIPTION OF THE INVENTION

The object of the invention relates to a faucet for pipes supplying water from water supply systems to consumers, comprising a body (1) determining a housing (2) in which a ball (3) is arranged in a leak-tight assembly between gaskets (4), with closure by means of a laterally coupled tubular bushing (5), the body (1) determining in the lower portion an outlet conduit (6) communicating with the housing (2), whereas in the upper portion, it determines a conduit (7); through which there is inserted a rod (8) provided with an end formation (9) fitting into a groove (10) of the ball (3) and incorporating a drive lever (11) at the other end to actuate the rotation of the ball (3) through the rod (8).

In the assembled arrangement, the rod (8) is secured with leak-tight coupling to the body (1) of the faucet by means of a packing gland (12), while the lever (11) is secured on the rod (8) by means of a retaining nut (13).

The ball (3) has a conduit (14) extending from a side area to the middle area, from where there is arranged in continuation another conduit (15) opening perpendicularly downwards.

Furthermore, another conduit (16) or a smaller diameter opens perpendicularly from one side to the conduit (14), in which a bushing (17) determining the passage diameter through said conduit (16) is arranged, such that said bushing (17) can be replaced for determining different passage diameters in the mentioned conduit (16). According to a preferred embodiment, the bushing (17) is envisaged to be made of Teflon, but making said bushing (17) from any other material does not alter the concept of the invention.

With that arrangement, the lower conduit (15) of the ball (3) communicates with the lower conduit (6) of the body (1) of the faucet and, depending on the angular position of the ball (3), according to the rotational actuation thereof by the lever (11), the conduit (14) or the conduit (16) are communicated with the conduit of the tubular bushing (5), or the blind portion opposite any of said conduits (14 or 16) is facing said conduit of the tubular bushing (5), said positions being determined with partial rotations of the ball (3) to 90°.

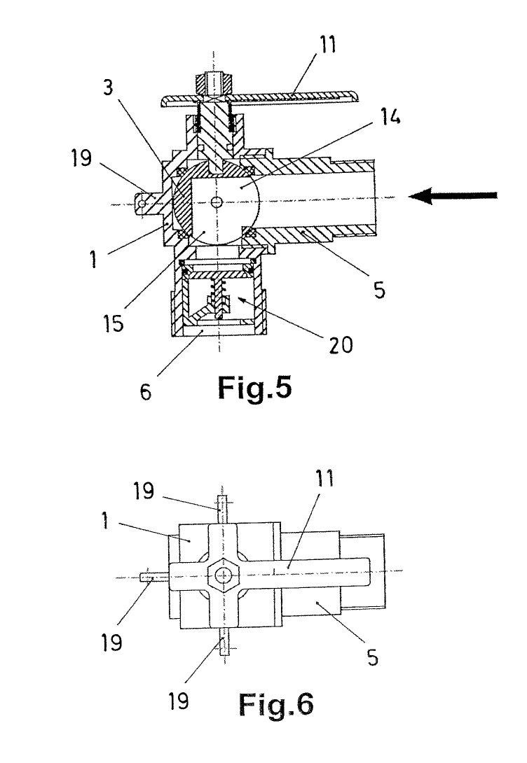

Therefore, by connecting the tubular bushing (5) to the portion where the flow arrives from a water supply pipe and the conduit (6) to the portion of the pipe going to the supply of application, the faucet allows establishing an open passage position, as shown in FIGS. 5 and 6, the ball (3) being located with the conduit (14) facing the conduit of the tubular bushing (5), such that the flow reaching the faucet completely passes through the ball (3), entering through the tubular bushing (5) and exiting through the conduit (6) .

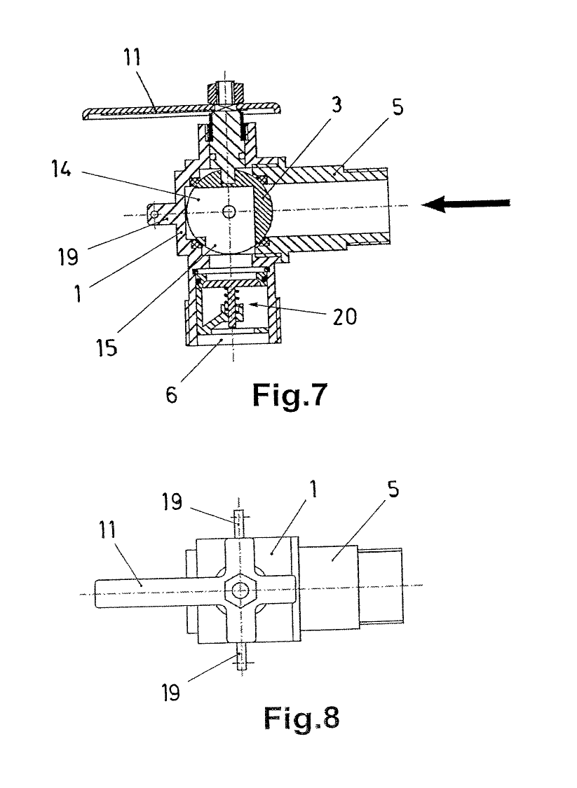

By means of rotating the ball (3) 180° with respect to the preceding position, a closed passage position is determined, as shown in FIGS. 7 and 8, in which the flow reaching through the tubular bushing (5) is completely cut off by the ball (3), such that no flow whatsoever passes to the conduit (6).

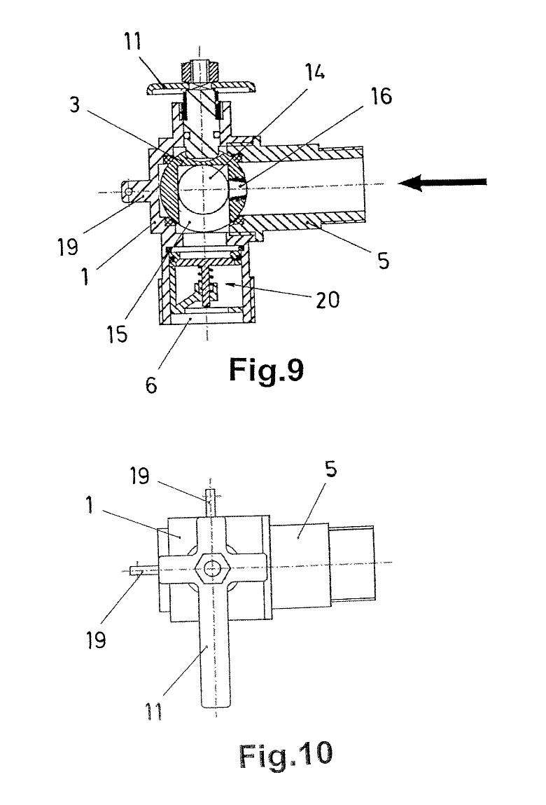

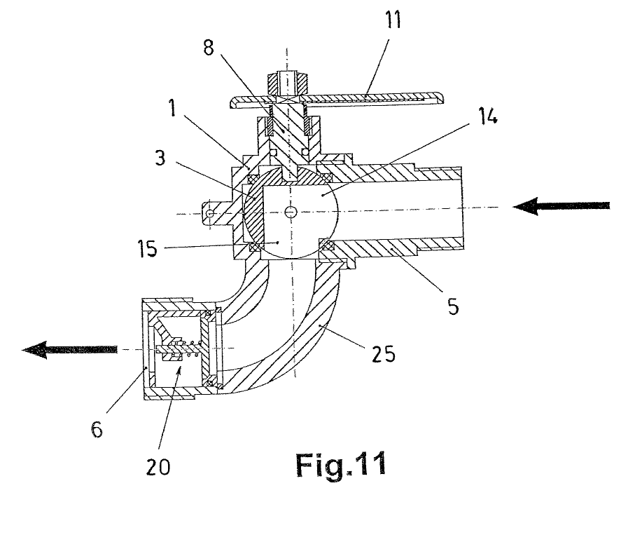

By means of rotating the ball (3) 90° from any of the preceding positions to one side, a position of reduced flow circulation through the faucet is in turn determined, as shown in FIGS. 9 and 10, the conduit (16) of a smaller diameter facing the conduit of the tubular bushing (5), such that the flow reaching the faucet through the tubular bushing (5) only partially passes through the ball (3) to exit through the conduit (6), which allows establishing a restricted supply when the supply must comply with certain limitations to the flow that is provided to users.

A strip (18) intended for establishing a sealed retention of the faucet in any of the functional positions is incorporated associated with the drive lever (11) for driving the rotation of the ball (3) by means of the rod (8), pins (19) provided with a hole, to which the end of the strip (18) can be selectively fitted and held with a sealing bead to immobilize the faucet in the desired functional position is envisaged in the body (1) of the faucet.

A check valve (20) is arranged in the outlet conduit (6) of the faucet, said valve being formed by a plunger (21) which is azially guided with respect to a support body (22) and is pushed by a spring (23) to a seal seat in which a gasket (24) is arranged, said check valve (20) determining a one-way flow circulation through the faucet.

In the structural embodiment, the faucet can be configured in any shape to best adapt to its intended applications, without it altering the functional concepts making up the object of the invention in relation to the possibility of selecting an open passage position, a closed passage position and a reduced passage position, for the applications of use. In that sense, the body of the faucet can have a bent prolongation (25) in the lower portion, for example, so that the outlet conduit (6) projects in a horizontal direction, as depicted in FIG. 11.

1. A three-position faucet for water supply systems, comprising: a body housing a ball arranged in a leak-tight assembly and with rotational capability for establishing positions for opening and closing the passage through the faucet between an inlet conduit and an outlet conduit, characterized in that the ball has a conduit extending from a side area to the middle area, from where there is arranged in continuation another conduit opening perpendicularly downwards, whereas another conduit of a smaller diameter opens perpendicularly from one side to the conduit, the lower conduit facing an outlet conduit defined by the body of the faucet, whereas depending on the rotation of the ball, the conduit, the conduit, or the blind portion opposite any of them can be arranged facing an inlet conduit defined by a tubular bushing coupled to the body, for establishing an open passage position, a reduced passage position, or a closed passage position, through the faucet, respectively.

2. The three-position faucet for water supply systems according claim 1, wherein the functional open passage, reduced passage and closed passage positions are determined by means of successive rotations of the ball in its assembly housing.

3. The three-position faucet for water supply systems according claim 1, wherein a bushing which can be replaced for determining different passage diameters in the conduit is arranged in said conduit.

4. The three-position faucet for water supply systems according claim 1, wherein a rod incorporating a drive lever for driving the rotation is arranged coupled to the ball, a strip that can be fitted into the pins of the body being linked to said lever to assure that all the functional positions of the faucet are sealed.

5. The three-position faucet for water supply systems according claim 1, a check valve determining a one-way flow circulation through the faucet is arranged in the outlet conduit.
